(19) United States
(12) Patent Application Publication
(10) Pub. No.: US 2006/0178138 A1
(43) Pub. Date: Aug. 10, 2006

(54) Access gateway, softswitch and telephone for push-to-talk telephony

(76) Inventors: Dan Ostroff, Petach Tikva (IL); Arye Shaham, Raanana (IL)

Correspondence Address: NATH & ASSOCIATES, 112 South West Street, Alexandria, VA, 22314, US

(21) Appl. No.: 11/052,860

(22) Filed: Feb. 9, 2005

(51) Int. Cl. H04Q 7/20

(52) U.S. Cl. 455/426.1

(57) ABSTRACT

An access gateway coupled to a Softswitch in a telephone communication system for establishing a Push-to-Talk channel between an originator and at least one destinator. The access gateway identifies an address of each destinator, and conveys respective DNRs of the originator and each destinator to the Softswitch for allowing the Softswitch to verify that the DNRs correspond to Push-to-Talk enabled telephones and that the originator is registered to establish a Push-to-Talk channel with each of the destinators. If so, the access gateway invokes an instruction received from the Softswitch to activate a speaker coupled to each of the destinators and establish a uni-directional voice channel from the originator to each of the destinators upon the destinators going off-hook. Destinators may complete the call for establishing a two-way voice channel to the originator. Enhanced telephones include Push-to-Talk facility, while existing telephones may be upgraded using an adapter.

### FIELD OF THE INVENTION

This invention relates to Push-to-Talk telephony.

### BACKGROUND OF THE INVENTION

As is well-known, Push-to-Talk allows a walkie-talkie type half-duplex communication to be carried out between registered users. Push-to-Talk communication requires the line access gateway to make a call from one line access gateway subscriber to another, either with or without dialing a number, and “burst into” the receiving party speakerphone without the called party having to pick up the handset or press any key. Once this has been done, the called party may optionally complete the call by depressing the Push-to-Talk actuator on his own telephone.

Typically, a transmitting telephone device has an address book containing telephone numbers of contacts with whom a session may be established. An initiator selects a recipient from the address book and a pushbutton is depressed, whereupon a half-duplex communication session is established with the selected recipient. The recipient is alerted, typically by a characteristic tone that informs him that the incoming call is a Push-to-Talk call. The recipient hears the originator breaking through his speaker.

WO 04/017651 (Schaefer et al.) published Feb. 26, 2004 and entitled “Push-to-talk/cellular networking system” describes a Push-to-Talk system for use with cellular telephony.

The Push-to-Talk over Cellular (PoC) Standard of the Open Mobile Alliance™ supports Push-to-Talk communication between participating cellular telephones that support the standard. If the recipient is equipped with a PoC-compatible device, he may at this stage depress a similar pushbutton on his device so as to establish a walkie-talkie type communication with the initiator. If the recipient is not equipped with a PoC-compatible device, then no service can be provided and in such case a tone indicating failure will be heard on the initiator device.

As opposed to the cellular network which allows wireless communication between parties, the Public Switched Telephone Network (PSTN) allows telephone communication between so-called wireline telephones (as opposite to wireless telephones) via the public exchange infrastructure. To this end, the PSTN is provided with exchanges that include banks of switches configured for coupling an originator being the telephone of a calling party, to a destinator being the telephone of a called party.

Many PSTN networks these days are going through the transition from TDM based technology to IP based technology. As part of this process, local exchanges are being replaced by softswitches which operate in conjunction with access gateways to effect the desired connection between originator and destinator.

Significant effort has been expended to incorporate Push-to-Talk in wireless and VoIP telephone networks. Push-to-Talk originates in the wireless communication environment where it has long been used for half-duplex communication by the military and more recently serves to provide effective and inexpensive communication between predefined groups of users such as taxi drivers and their dispatcher and other itinerant users who need to be in constant communication with each other or with a fixed base. It is therefore probably not so surprising that its implementation in cellular telephony has been given priority. The incentive to do so has been further enhanced by the relative high cost of cellular telephony, particularly when both parties use different cellular service providers.

However, the implementation of Push-to-Talk has by no means been confined to cellular or other wireless telephone communication.

U.S. Pat. No. 6,792,091 (Lemchen et al.) published Sep. 14, 2004 and entitled “Network-based intercom system and method for simulating a hardware based dedicated intercom system” discloses a network-based intercom system and method comprising software for use with a computer network on which it is implemented. The software includes a dispatcher portion to be installed on any of the computers of the network, and an intercom module portion to be installed on each of the participating computers in the system. Automatic message receipt without unnecessarily interrupting a recipient is achieved by signaling that a message has been sent by an assigned audible tone that is unique to the addressee. Thus, the recipient becomes aware that he or she has automatically received a message. The message is displayed in a banner on the addressee's computer monitor for selective viewing based on an order of priority relates to an IP based intercom using a software phone.

This reference relates to VoIP telephony over the Internet and does not appear to relate to PSTN telephony using POTS (plain old telephone service) telephones.

WO 04/075581 (Hannu) published Sep. 2, 2004 and entitled “A method and system for setting application settings for a Push-to-Talk service” relates to Push-to-Talk in a multimedia system over VoIP. It does not relate to PSTN using POTS telephones.

U.S. Pat. No. 6,763,226 (McZeal Jr.) published Jul. 13, 2004 discloses a multifunctional world wide walkie talkie, cellular-satellite wireless instant messenger computer and network for establishing global wireless VoIP communications, unified messaging, and video conferencing via the Internet. Such a network is directed to the need to interface the PSTN with the protocol of the Internet to integrate digital services. Pressing a Push-to-Talk button invokes a program that initiates a communications session over the Internet or other network between two or more users. Telephone calls are routed directly through the Internet using Voice Over Internet Protocol (VoIP) in conjunction with an Internet based web server which contains all the necessary software, hardware, and gateways for routing telephone calls via the Internet. Calls are placed over the Internet rather than the PSTN and the Internet based web server then routes the call back to correct telephone number on the PSTN. In the event the requested user is a member of the same network, or is present via Instant messaging, the call is routed to the requested user without the need of routing the call to the PSTN.

It is thus apparent that U.S. Pat. No. 6,763,226 operates principally using VoIP over the Internet rather than wireline telephones that are connected to the PSTN. However, there is no teaching to provide Push-to-Talk telephony directly or principally over the PSTN such that POTS telephones used with the PSTN can initiate or receive Push-to-Talk telephony and there is no teaching relating to an access gateway or Softswitch that is used in the PSTN to facilitate this.

It would therefore clearly be desirable and a significant benefit if enhanced POTS telephones could establish Push-to-Talk sessions via the PSTN.

### SUMMARY OF THE INVENTION

It is an object of the invention to provide an enhancement to the PSTN for allowing POTS telephones to establish Push-to-Talk sessions directly via the PSTN.

This object is realized in accordance with a first aspect of the invention by an access gateway for a telephone communication system adapted to receive a call signal from an originator indicative of a desire to establish a Push-to-Talk channel with at least one destinator, said access gateway comprising:

an identification unit for identifying an address of each destinator, a communication port for conveying respective DNRs of the originator and each destinator to a Softswitch coupled to the access gateway for allowing the Softswitch to verify that the DNRs correspond to Push-to-Talk enabled telephones and that the originator is registered to establish a Push-to-Talk channel with each of said destinators, if so, for conveying to each of the destinators an instruction received from the Softswitch to activate a speaker coupled to each of the destinators, and

a half-duplex switch responsive to the or each destinator going off-hook for establishing a one-way voice channel from the originator to each of the destinators.

According to a further aspect of the invention there is provided a Softswitch for a telephone communication system adapted to receive a call signal from an originator coupled to the Softswitch via an access gateway, said call signal being indicative of a desire to establish a Push-to-Talk channel with at least one destinator, said Softswitch comprising:

a communication port for receiving respective DNRs of the originator and each destinator from the access gateway, and

a verification unit coupled to the communication port for verifying that the DNRs correspond to Push-to-Talk enabled telephones and that the originator is registered to establish a Push-to-Talk channel with each of said destinators, and

an instruction unit coupled to the verification unit and responsive to the DNRs corresponding to Push-to-Talk enabled telephones and to the originator being registered to establish a Push-to-Talk channel with each of said destinators for sending an instruction to the access gateway for instructing the access gateway to activate a speaker coupled to each of the destinators and establish a uni-directional voice channel from the originator to each of the destinators.

According to yet another aspect of the invention there is provided an adapter for enabling a destinator to receive a Push-to-Talk call from an originator, the adapter comprising:

a connector for connecting to the destinator, and

a half-duplex switch responsive to an instruction for activating a speaker coupled to the destinator and establishing a unidirectional voice channel from the originator to the destinator.

According to a still further aspect of the invention there is provided a method for providing a “baby-sitting” service between an originator and a destinator, the method comprising:

locating an originator telephone having Push-to-Talk capability in voice proximity to an infant;

locating a destinator telephone having Push-to-Talk capability in voice proximity to a baby sitter, said originator and destinator telephones being registered to establish a Push-to-Talk channel with each other; and

responsive to the baby expressing distress by sound, establishing a Push-to-Talk channel between the originator and the destinator so as to enable the destinator to hear the baby via a one-way voice channel.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIGS. 1 and 2 show pictorially representations of communication systems according to alternative embodiments for allowing an originator to invoke Push-to-Talk communication with at least one destinator;

FIG. 3 schematically shows a client-server system suitable for implementing an exemplary, non-limiting embodiment;

FIG. 4 schematically shows a specific architecture of the client-server system depicted in FIG. 3;

FIG. 5 is a block diagram showing the functionality of an enhanced telephone adapted to convey Push-to-Talk messages to one or more destinators;

FIG. 6 is a block diagram showing the functionality of an adapter for use with a POTS telephone so as to provide Push-to-Talk capability;

FIGS. 7 and 8 are block diagrams showing respectively the functionality of an enhanced line access gateway and an enhanced Softswitch that are adapted to co-operate for conveying Push-to-Talk messages between an originator and destinator in accordance with an exemplary, non-limiting embodiment;

FIGS. 9 and 10 are flow charts showing respectively the principal operations carried out by an enhanced line access gateway and an enhanced Softswitch in accordance with another exemplary, non-limiting embodiment;

FIG. 11 is a flow chart showing the principal operations carried by a method for providing a baby-sitting service between an originator and a destinator using the system shown in FIGS. 1 and 2; and

FIGS. 12 to 15 are schematic ‘Call Flow’ diagrams showing signaling between two telephones during different stages of Push-to-Talk sessions in accordance with exemplary, non-limiting embodiments.

### DETAILED DESCRIPTION OF EXEMPLARY EMBODIMENTS

The present invention will now be described in detail by describing illustrative, non-limiting embodiments thereof with reference to the accompanying drawings. In the drawings, the same reference characters denote the same elements.

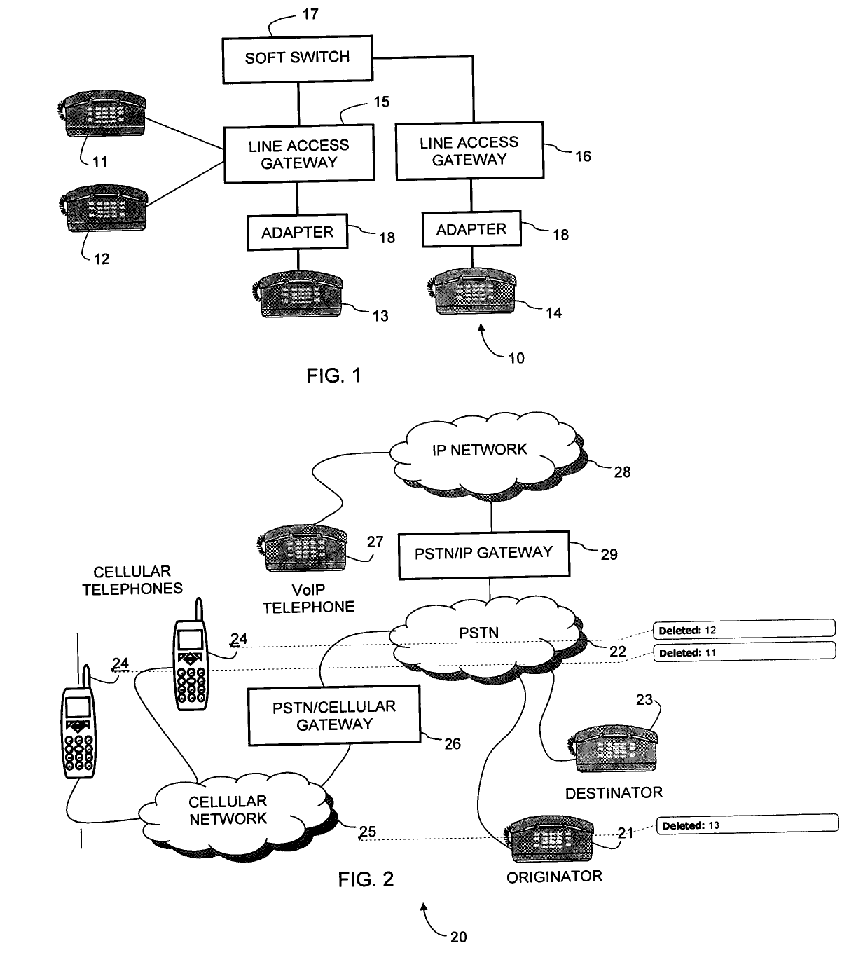

FIG. 1 pictorially shows a part of the PSTN 10 comprising a plurality of telephones of which only four are shown designated 11-14, respectively. Switching between telephones 11-14 is performed via one or more line access gateways 15 and 16 both operatively coupled to a Softswitch 17. The line access gateways 15 and 16 and the Softswitch 17 may be compatible with MGCP or MEGACO or SIP or any other suitable protocol. Push-to-Talk communication is offered as a service to which telephone subscribers may subscribe, typically on payment of a subscription fee to a Push-to-Talk service provider. Upon registering for such a service, a subscriber must provide the telephone number or alias of another subscriber or group of subscribers with which Push-to-Talk communication is required. In a simple scenario, a calling party (hereinafter referred to as an “originator”) presses a button on his telephone in order to establish direct Push-to-Talk communication with a single specific party (hereinafter referred to as a “destinator”). In such a simple scenario, there is no need for the originator to indicate the telephone number (referred to hereinafter as “DNR”) of the destinator because this has already been recorded by the Push-to-Talk service provider upon registering for the service. More generally, the originator may send Push-to-Talk messages to more than one registered destinator. In such case, the DNRs of all required destinators must be registered with the Push-to-Talk service provider.

Registration is required by both the originator and the destinator since the destinator must grant permission to the service provider to convey Push-to-Talk communication from the registered destinator. Moreover, both the originator and the destinator must be equipped with telephones that are Push-to-Talk enabled not only in order that the originator can send a Push-to-Talk message but also in order that the destinator will be able to hear it and respond, if necessary. To this end, the telephones 11-14 must either be customized to provide for this service or, alternatively, an adapter 18 may be coupled to the telephones for enabling them to send and receive Push-to-Talk messages without the need for customization.

Registration may be carried out in any manner that informs the operator of registration including the following:

1.) Keying an authorization code into the telephone;

2.) Using a computer device such as a web interface;

3.) Calling the operator;

FIG. 2 is a pictorial representation of a hybrid system 20 for conveying Push-to-Talk messages between an originator 21 connected to the PSTN 22 and one or more destinators such as telephone 23 also connected to the PSTN. The originator and/or the destinators need not be connected to the PSTN and may, instead, be cellular telephones 24 connected to the cellular network 25 that is connected to the PSTN 22 via a PSTN/Cellular gateway 26. Alternatively, the originator and/or the destinators may be VoIP telephones 27 connected to an IP network 28 that is connected to the PSTN 22 via a PSTN/IP gateway 29. The PSTN 22 thus serves as a conduit to the cellular network 25 via the PSTN/Cellular gateway 26 and serves as a conduit to the IP network 28 via the PSTN/IP gateway 29.

In such a hybrid system 20, signaling and media are conveyed from one network to another via the PSTN/Cellular gateway 26 and/or the PSTN/IP gateway 29, which operate in a manner well known in the art to convert the signals between PSTN and IP or PSTN and Cellular protocols and vice versa. The present invention is not directly concerned with the protocols used to establish Push-to-Talk but rather is directed to modifications that must be made to the line access gateways 15 and 16 and to the Softswitch 17 shown in FIG. 1 as well as to the PSTN telephones 11-14 shown in FIG. 1 and 21 and 23 shown in FIG. 2 in order to facilitate Push-to-Talk over the PSTN. However, although the Push-to-Talk protocol is not itself a feature of the invention, it is known that the cellular network 25 is already essentially Push-to-Talk enabled via the PoC protocol of the Open Mobile Alliance™ and a similar approach may be used to implement Push-to-Talk also by the PSTN 22 and the IP network 28. The PoC Standard is public and is described in their draft Standard OMA-RD_PoC-V1_{—}0-20031204-D available from their website and is incorporated herein by reference. Many of the features supported by this standard are amenable to implementation by one skilled in the art based on the information in this standard.

The PSTN/Cellular gateway 26 and the PSTN/IP gateway 29 should either emulate a Push-to-Talk (PtT) protocol in respect of the telephones in the respective networks or at the very least serve as conduits to convey Push-to-Talk messages to and from the cellular network 25 and/or the IP network 28.

By way of an example, so far as the IP network 28 is concerned, the PSTN/IP gateway 29 functions as an intermediate destinator that receives signaling and media from the originator 21 in the PSTN 22. In the IP network 28, the signaling and media are received together. The PSTN/IP gateway 29 places the signaling and media in the same path and the IP network 28 allows connection to the VoIP telephone 27 that is registered as a destinator in respect of the originator 21. A Push-to-Talk message conveyed by the originator 21 is directed by the PSTN 22 to the PSTN/IP gateway 29, which in turn determines that the required destinator is either a cellular telephone 24, in the cellular network 25 or the VoIP telephone 27 in the IP network 28.

When the destinator is a cellular telephone 24 the message reaches the PSTN/-Cellular gateway 26, which determines that the destination address is a telephone in the cellular network 25. When the destinator is the VoIP telephone 27, the PSTN/IP gateway 29 receives the signaling and media from the PSTN 22, where the signaling and the media travel on separate paths in the PSTN 22. Then, the PSTN/IP gateway 29 performs the required protocol conversion, and re-directs the signaling and media on a common path in the IP network 28 to the VoIP telephone 27. The PSTN/IP gateway 29 converts IP network messages to the necessary format for the PSTN 22.

Thus, the exemplary embodiment allows Push-to-Talk messages to be conveyed wholly within the PSTN, the cellular network or the IP network, as well as allowing Push-to-Talk functionality between the PSTN and the other two networks.

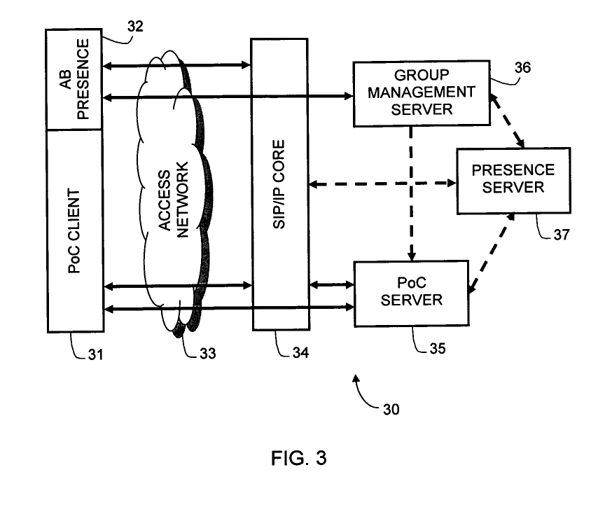

FIG. 3 schematically shows a client-server system 30 suitable for carrying out an exemplary, non-limiting embodiment. The system 30 includes a PoC client 31 having an optional AB presence unit 32. The PoC client 31 is coupled via an access network 33 to a SIP/IP core 34 and thence to a PoC server 35, thus allowing bidirectional communication between the PoC client 31 and the PoC server 35. The AB presence unit 32 is likewise coupled to the SIP/IP core 34 and thence to a Group Management Server 36. Optionally, a presence server 37 coupled to the SIP/IP core 34 and to the PoC server 35 and the Group Management Server 36 may also be provided.

The AB presence unit 32 is a client that connects to the presence server 37 to provide presence and service identification data. The PoC client 31 does not obtain this data directly from the presence server but rather takes data provided by the presence client (the AB presence unit 32) and uses this data to update the presence data and the service information received from the network. If the presence information (information about the properties of potential target devices) is not required, then both the AB presence unit 32 and the presence server 37 may be dispensed with. Otherwise, both the AB presence unit 32 and the presence server 37 are needed.

The system 30 depicts a standard arrangement for a PoC telephony as described in the above-referenced PoC Standard of the Open Mobile Alliance™ and will therefore not be described in detail. It is, however, noted that the above-referenced PoC Standard relates specifically to Push-to-Talk over Cellular and is not equipped for use with PSTN telephones. In order for PSTN telephones to be Push-to-Talk enabled using the PoC Standard (or any other suitable protocol), it is necessary to make enhancements to the PSTN telephone devices 11-14, to the line access gateways 15, 16 and to the Softswitch 17 (all shown in FIG. 1) and the remaining description will therefore relate to these exemplary enhancements.

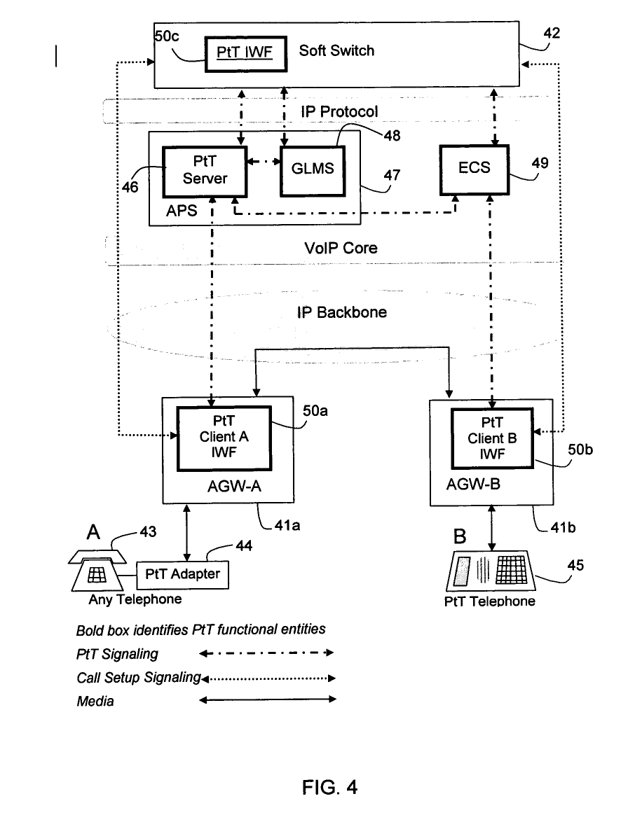

FIG. 4 schematically shows a specific architecture of the client-server system depicted in FIG. 3. The PtT Architecture is based on the architecture of a network 40 which connects subscribers to an Access Gateway shown as two component units 41a (AGW-A) and 41b (AGW-B), each of which is connected to a Softswitch (SSW) 42. The Softswitch 42 is an entity in an IP network which is responsible for the logic of call establishment. The Access Gateway 41a, 41b is the part of the network 40 to which the telephones are physically connected, for example by copper wires. By way of explanation, reference is made to a regular POTS telephone 43 coupled via an adapter 44 to the Access Gateway 41a and to an enhanced Push-to-Talk telephone 45 connected to the Access Gateway 41b. The adapter 44 is a device which is implemented as a subset of the Push-to-Talk Telephone. Its purpose is to connect to a regular telephone (POTS), and turn it into a Push-to-Talk enabled unit. The Push-to-Talk Telephone 45, is an enhanced telephone that includes all the facilities of a regular telephone, but also all the facilities required in order to fully activate the Push-to-Talk features.

Calls between subscribers of the Access Gateway 41a, 41b and the Softswitch 42 use signaling which passes via the IP network. The signaling used for the Push-to-Talk feature may be implemented in MGCP, MEGACO, SIP, or other protocols. The implementation of the Push-to-Talk feature will now be described in functional terms, not limited to any protocol.

The Softswitch 42 and the Access Gateway 41a, 41b are elements that communicate in an ordinary phone call. The arrows shown in FIG. 4 that designate the signaling between the Access Gateway 41a, 41b and the Softswitch 42 show the normal call process signaling in VoIP calls. The solid arrows connecting between the Access Gateway 41a, 41b via the IP backbone, show the passing of the media (the voice itself). The arrows connecting the Access Gateway 41a, 41b and the Softswitch 42 to the Push-to-Talk entities designate the Push-to-Talk specific signaling.

The implementation of the Push-to-Talk feature includes a Push-to-Talk Server 46 which is an entity within an Application Server 47, responsible for the Push-to-Talk feature logic. It cooperates with the GLMS (Group List Management Server) 48 which is the entity within the Application Server 47 that stores and manages all the information that is needed in order to handle the Push-to-Talk subscriber groups, authorizations, status ect. The Push-to-Talk Server 46 also communicates with an Event Control Server (ECS) 49 by notifying it when a Push-to-Talk call has started, ended, or failed.

Each of the above Push-to-Talk dedicated functions (Push-to-Talk Server, GLMS, ECS) can be implemented physically within the Softswitch, or within other entities in the network.

With each part of the Access Gateway 41a, 41b there is implemented a Push-to-Talk Client IWF (Interworking Function) dedicated to deal with Push-to-Talk calls. Thus, in FIG. 4 there is shown a Push-to-Talk Client A IWF 50a within the Access Gateway 41a that handles Push-to-Talk calls for the telephone 43, shown as “A” in the figure. Likewise, a Push-to-Talk Client B IWF 50b is implemented in the Access Gateway 41b that handles Push-to-Talk calls for the Push-to-Talk telephone 45, shown in the figure as “B”. Similarly, a Push-to-Talk IWF 50c is implemented in the Softswitch 42 that handles Push-to-Talk calls originated or terminated by the Access Gateway 50.

### Push-to-Talk Telephone End-User Equipment

In order to activate the Push-to-Talk telephone feature using a push-button, a subscriber needs to have a special telephone connected to its subscriber line. In order to receive a Push-to-Talk telephone call, the receiving party must also have an enhanced telephone shown as 45 in FIG. 4 that allows a caller to ‘burst’ into its microphone, if the caller is authorized to do so (by means of provisioning).

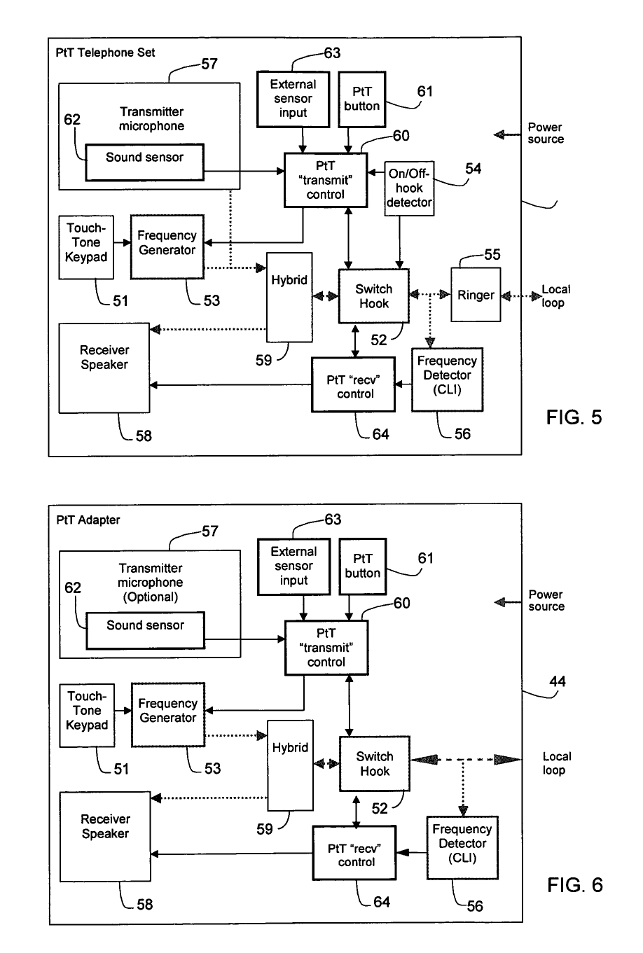

FIG. 5 illustrates the architecture of the enhanced Push-to-Talk telephone 45 that comprises a touch-tone keypad 51 and a switch hook 52 that isolates the telephone set/device from the local loop in the off-hook state via a set of electrical contacts. A frequency generator 53 is coupled to the touch-tone keypad 51 and converts key entries to DTMF signals. An On/Off hook detector 54 generates an off-hook signal when the telephone handset is lifted. A ringer 55 provides a ring signal and is constituted by an electromagnetic or piezoelectric sound transducer. The AC signal to the transducer is applied to the loop in timed ON and OFF intervals to produce a ringing cadence. A frequency detector (CLI) 56 is a unit that provides on-hook Caller ID function such as line polarity reversal detection, Frequency Shift Keying demodulation and CPE Alerting Signal detection. A transmitter (microphone) 57 is an electro-acoustic transducer that converts the varying pressure of a sound wave corresponding to a subscriber's voice to a varying current or voltage. A receiver (speaker) 58 does the opposite and converts the varying electrical current representing a transmitted speech signal to variations in air pressure hearable by the human ear. Hybrid 59 is a multi-winding transformer that interfaces a 2-wire circuit to a 4-wire circuit. These are all components that are found in a regular telephone set and so will not be described in more detail.

The following components are added to the standard components described above to provide the Push-to-Talk functionality. In order to actuate the Push-to-Talk facility, three different types of actuator are provided and convey an actuation signal to a Push-to-Talk “transmit” control unit 60 that has an input coupled to the On/Off hook detector 54 and has outputs coupled to the switch hook 52 and to the frequency generator 53. A first actuator is a Push-to-Talk button 61 which is pressed to initiate a Push-to-Talk call, and released when the initiator finishes talking. A second actuator is a sound sensor 62 adapted to produce a sound whose amplitude exceeds a pre-determined threshold for a predefined period of time. Such a sensor is used in the Baby-Sitter application described below with reference to FIG. 15 of the drawings. A third actuator is an external sensor 63 that is adapted to initiate a Push-to-Talk call for a predefined period of time, and may allow an alarm system, to initiate a Push-to-Talk call. Such an alarm system may be a home burglary alarm system. Likewise, the alarm system may include a national system connected to the Push-to-Talk telephone for warning in case of global dangers such as tsunami, missile attack, etc.

The Push-to-Talk “transmit” control unit 60 is responsive to the Push-to-Talk call initiation signal for controlling the switch hook 52 and the frequency generator 53. If there is a Push-to-Talk call event and the loop is not already active (i.e. there is no other call currently pending) the Push-to-Talk “transmit” control unit 60 initiates an off hook state and then initiates a frequency sequence that indicates to AGW-A 41a of the start of a Push-to-Talk call. The off-hook state is maintained while the event continues, or for a predefined period of time.

A Push-to-Talk “recv” control unit 64 has an input coupled the frequency detector (CLI) 56 and has outputs coupled to the receiver (speaker) 58 and to the switch hook 52. The Push-to-Talk “recv” control unit 64 receives an indication of an incoming Push-to-Talk call and generates an alert tone that is vocalized by the receiver (speaker) 58 so as to inform a destinator subscriber that the incoming call is a Push-to-Talk call. It can also generate predefined tones on the speaker 58 to indicate start and stop of the incoming Push-to-Talk call. The indication source can be a Push-to-Talk call Caller Line Identification. However, it will be appreciated that other indication methods may be used, such as metering signals that are applied to the loop. The Push-to-Talk “recv” control unit 64 initiates an off hook state that is maintained while the AGW-B port 41b is active.

It has already been noted that Push-to-Talk communication requires the line access gateway to make a call from one line access gateway subscriber to another, either with or without dialing a number, and “burst into” the receiving party speakerphone without him having to pick up the handset or press any key. In advanced PSTN telephones having a speakerphone, an incoming Push-to-Talk message requires that the speakerphone be activated even though the called party has not lifted the handset. Once this has been done, the called party may optionally complete the call as noted above by depressing the Push-to-Talk actuator on his own telephone. On the other hand, existing PSTN telephones do not have a speakerphone or actuator. It is clearly desirable to be able to send Push-to-Talk messages to such telephones and to initiate Push-to-Talk calls therefrom without the need to replace the telephones.

In this case the Push-to-Talk feature may be activated by the Push-to-Talk adapter shown as 44 in FIG. 4 and which will now be described with particular reference to FIG. 6. The Push-to-Talk adapter 44 is connected in parallel to the subscriber's conventional PSTN telephone and adds the missing functionality. The Push-to-Talk adapter 44 is very similar to the Push-to-Talk telephone 45 described above with reference to FIG. 5 but lacks the ringer 55 and the On/Off hook detector 54 that are integral components of the conventional telephone. Likewise, the touch-tone keypad 51 and the microphone 57 are optional The microphone 57 is needed only as a sound sensor for the Baby-Sitter application to be described below with reference to FIG. 15 of the drawings.

There is also provided an option to initiate a Push-to-Talk call by removing the handset of the telephone set off-hook and dialing a specific Push-to-Talk number. In this case all the transmit side of the Push-to-Talk adapter 44 is optional. The dialing is done with the regular telephone.

The adapter 44 may also include a full-duplex switch (not shown) for establishing a two-way voice channel between the originator and the destinator. Typically, this is a pushbutton switch of the kind push-to-close release-to-open. Depressing this switch sends a signal to the line access gateway which opens an audio channel between the destinator and the originator. It will, of course, be appreciated that the full-duplex switch may instead be in the telephone. Likewise, it will be understood that the functionality of the adapter may be incorporated within the telephone as shown in FIG. 5.

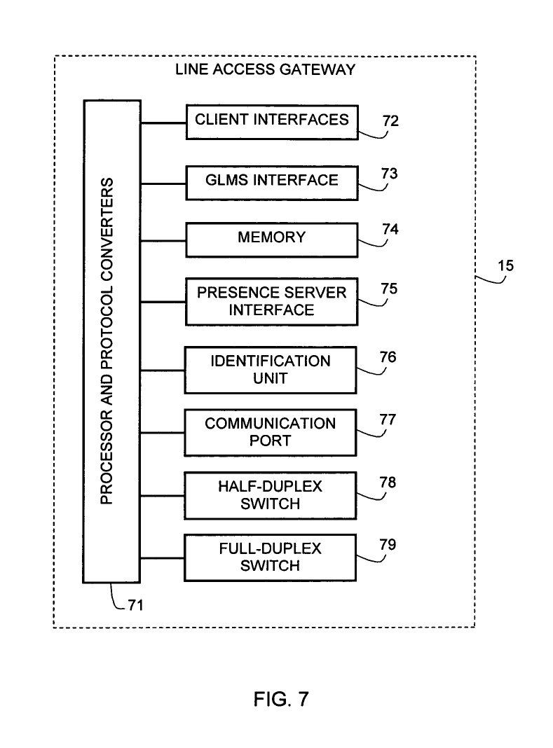

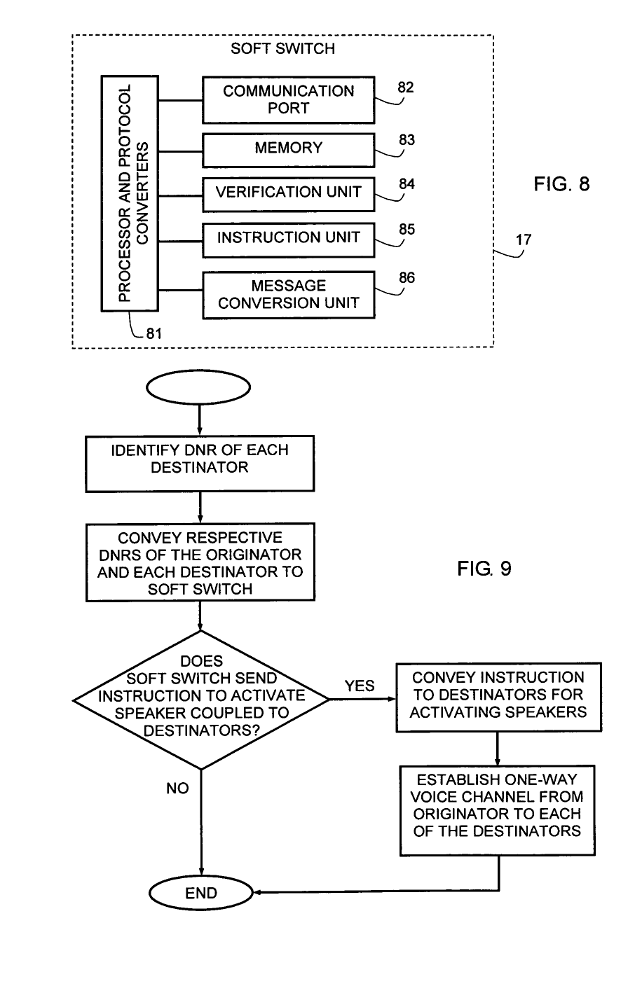

FIG. 7 is a block diagram showing the functionality of the line access gateway 15 shown in FIG. 1 and also referred to herein as access gateway adapted to convey receive Push-to-Talk messages between an originator and a destinator according to an exemplary, non-limiting embodiment of the present invention. The line access gateway 15 has a processor and protocol converters shown generally as 71. Furthermore, the line access gateway 15 has client interfaces 72 that are coupled to the processor 71 and serve as first and second interfaces for coupling to respective first and second telephone devices, both of which have a display are equipped to send and receive Push-to-Talk messages. A GLMS interface 73 allows groups to be defined so that an incoming call directed to one member of the group may be automatically sent to the other members of the group. Accordingly, multicast transmissions may be conveyed to several parties simultaneously. A memory 74 may be provided for storing data pertaining to registered users, such as the DNRs of one or more other registered users to whom Push-to-Talk messages should be conveyed. Alternatively, as described below with reference to FIG. 8, this data may be stored in the Softswitch or otherwise accessible to the Softswitch so as to allow the Softswitch to verify that the DNRs relate to registered users and that the originator is authorized to send PTT to the destinator. Thus, in the preferred embodiment shown in FIG. 4, this data is stored in a database maintained by the Push-to-Talk server 46 so as to be accessible to both the Softswitch 42 and the access gateway 41a, 41b. A presence server interface 75 allows connection of the optional presence server 37 as described above with reference to FIG. 3. An identification unit 76 is coupled to the processor 71 for identifying an address (DNR) of each destinator to which Push-to-Talk messages should be conveyed. As noted above, this may be based on a table of registered destinators to be associated with the originator as provided by the originator when subscribing to the Push-to-Talk service. Alternatively, the DNRs of requested destinators may be conveyed by the originator when depressing the Push-to-Talk actuator 43. In such case, the originator may be equipped with the address book 45 and selector 46 as described above with reference to FIG. 4. In the case, where all data is pre-registered and stored in the memory 74 of the line access gateway, these features are not required in the originator.

A communication port 77 is coupled to the processor 71 for conveying respective DNRs of the originator and each destinator to the Softswitch 17 coupled to the access gateway for allowing the Softswitch to verify that the DNRs correspond to Push-to-Talk enabled telephones and that the originator is registered to establish a Push-to-Talk channel with each of the specified destinators. If so, the communication port 77 receives an instruction from the Softswitch to activate a speaker coupled to each of the destinators and conveys the instruction to each of the destinators. It is to be noted that the instruction may undergo conversion or encoding such that the actual data received from the Softswitch is modified before being conveyed to the destinators. However, regardless of the actual data that is conveyed, the instruction that is conveyed informs the destinator to activate the speaker and thereby allow a Push-to-Talk message sent by the originator to be vocalized at the destinator(s). A half-duplex switch 78 is responsive to the destinator(s) going off-hook (i.e. activating its speaker) for establishing a one-way voice channel from the originator to each of the destinators. A full-duplex switch 79 is responsive to one or more destinators completing the call for establishing a two-way voice channel between the originator and these destinators.

FIG. 8 is a block diagram showing the functionality of the Softswitch 17 shown in FIG. 1. It will be understood by those skilled in the art that the functionality of the Softswitch 17 may be distributed in which case the components shown in FIG. 8 while logically associated with the Softswitch 17 may physically reside elsewhere. The Softswitch 17 includes a processor and protocol converters shown generally as 81 and a communication port 82 coupled to the processor 81 for receiving respective DNRs of the originator and each destinator from the access gateway 15 or 16. As noted above, a memory 83 may be provided for storing data pertaining to registered users, including the DNRs of one or more other registered users to whom Push-to-Talk messages should be conveyed. A verification unit 84 is coupled to the processor 81 and is responsive to the DNRs conveyed by the communication port 82 for accessing the memory 83 to verify that the DNRs correspond to Push-to-Talk enabled telephones and that the originator is registered to establish a Push-to-Talk channel with each of the specified destinators. An instruction unit 85 is coupled to the processor 81 and is responsive to the verification unit 84 determining that the DNRs correspond to Push-to-Talk enabled telephones and that the originator is registered to establish a Push-to-Talk channel with each of the specified destinators for sending an instruction to the line access gateway 15 for instructing the line access gateway to activate a speaker coupled to each of the destinators and establish a uni-directional (i.e. half-duplex) voice channel from the originator to each of the destinators.

In the case that the originator and one or more destinators are in different types of telephone network, data included in the Push-to-Talk message identifying it as a Push-to-Talk message must be identified by the Softswitch in the destinator network. To this end, the Softswitch is provided with a message conversion unit 86 that receives and parses an incoming message and, upon identifying it as a Push-to-Talk message, informs the destinator network accordingly so that the message can be routed to the destinator as a Push-to-Talk message. This is of particular relevance in a hybrid network of the kind described above with reference to FIG. 2 where the originator and destinator can be different types of telephone, such as PSTN, cellular, VoIP and so on.

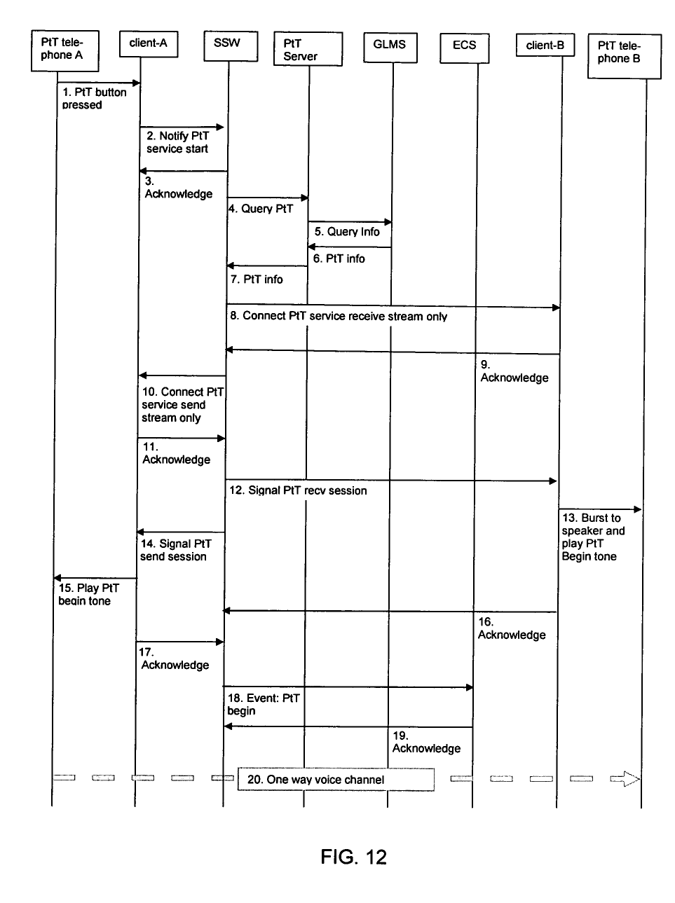

Exemplary operation of the line access gateway and the Softswitch will now be described with reference to FIGS. 9 to 11 showing the principal operations carried out in accordance with different embodiments of the invention and with reference to FIGS. 12 to 15 being ‘Call Flow’ diagrams showing signaling between two telephones one of which conveys a Push-to-Talk message to the other in accordance with different embodiments of the invention.

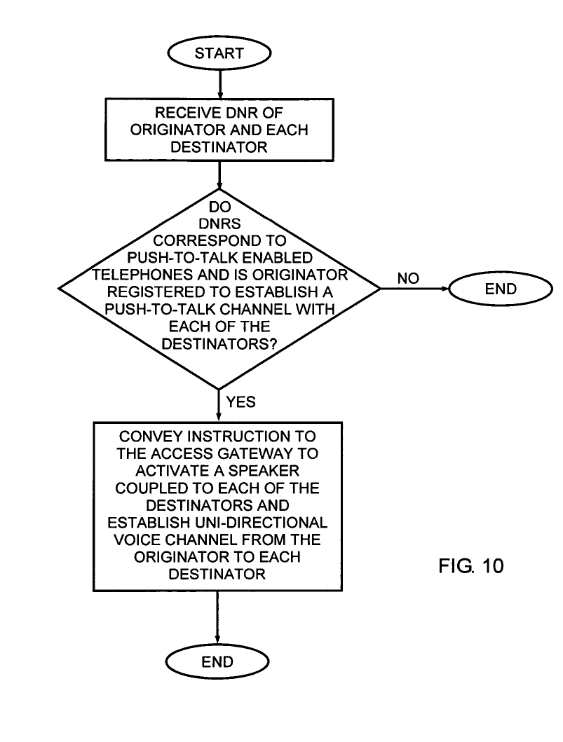

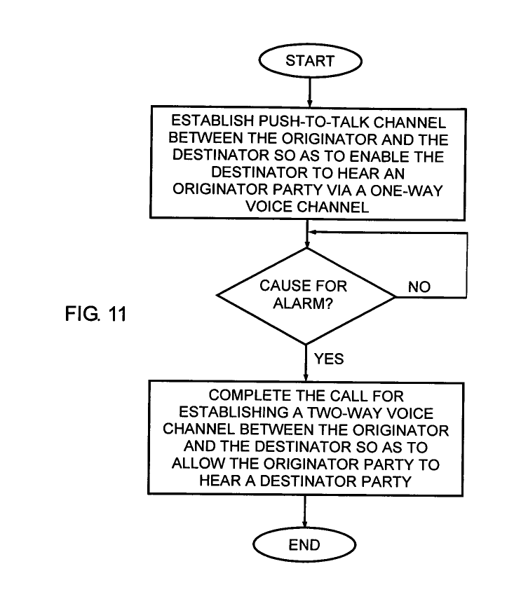

FIGS. 9 and 10 are flow diagrams showing the principal operations carried out by the access gateway 41a, 41b and the Softswitch 42 in conveying Push-to-Talk messages from the originator and destinator telephones in accordance with an embodiment of the invention. The access gateway identifies the DNR of each destinator and conveys the respective DNRs of the originator and each destinator to the Softswitch. The Softswitch checks that the DNRs correspond to Push-to-Talk enabled telephones and that the originator is registered to establish a Push-to-Talk channel with each of the destinators. If so, the Softswitch 42 conveys an instruction to the access gateway to activate a speaker coupled to each of the destinators and establish uni-directional voice channel from the originator to each destinator. The access gateway instructs the destinators to activate the speakers FIG. 11 is a flow chart showing the principal operations carried by a method for providing a baby-sitting service between an originator and a destinator using the system shown in FIGS. 1 and 2. A “baby minder” leaves the baby in close proximity to an enhanced telephone according to the invention. The baby's telephone is the originator and the baby minder's telephone is the destinator.

A baby sitter locates a Push-to-Talk telephone near a sleeping infant for establishing a Push-to-Talk channel between the infant's telephone and the baby sitter's telephone, which most typically is a cellular telephone which the sitter carries although it can be any registered Push-to-Talk-enabled telephone in hearing proximity to the baby sitter. The infant's telephone is thus the originator and the baby sitter's telephone is the destinator. The baby's telephone is setup to establish a Push-to-Talk channel with the baby sitter's telephone when the volume of the baby's voice exceeds a certain level as determined by the sound sensor 62 described above with reference to FIGS. 5 and 6 of the drawings. This may be implemented using a voiced detection method (“VOX”) that activates the Push-to-Talk feature when the noise amplitude exceeds a set threshold. By thus establishing a Push-to-Talk channel between the originator and the destinator, the baby sitter can hear the infant (constituting an originator party) via a one-way voice channel.

When the baby sitter hears the baby's voice, the baby sitter can determine whether there is cause for alarm. If so, the baby sitter can attempt to calm the baby remotely either by completing the call or by establishing a return one-way Push-to-Talk communication with the baby if the volume of the baby's crying falls below the threshold level and thus terminates the Push-to-Talk channel to the baby sitter's telephone.

These processes will now be described in more detail by means of Call Flow diagrams shown in FIGS. 12 to 15.

### Push-to-Talk Call Process

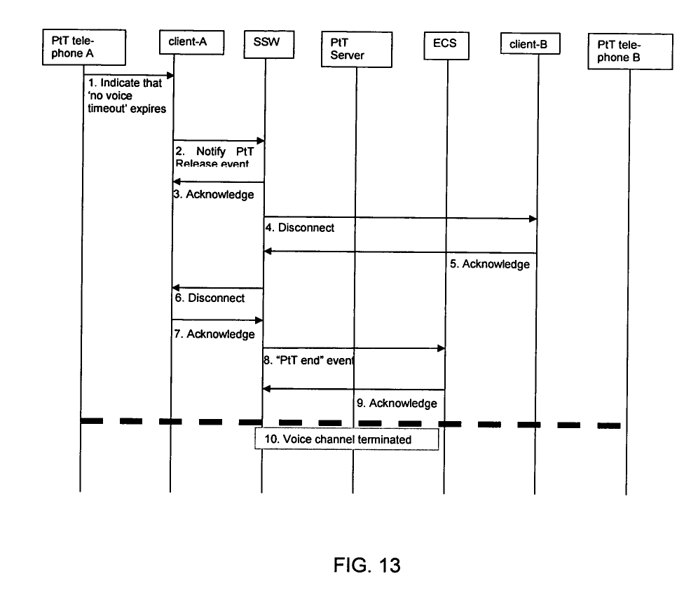

A Push-to-Talk session is a VoIP one way phone call. The call process will now be described in two parts with reference to the Call-Flow diagrams in FIGS. 12 and 13. The first is the call setup which is initiated when an originator presses the Push-to-Talk button on its Push-to-Talk phone, and ends once a one-way voice path is established. The call lasts for as long as the button is pressed (unless a timer has expired).

The second part of the process described is the session tear-down, which is initiated when the button is released.

The call scenarios are described in a way that can be implemented in any of the commonly used protocols such as SIP, MGCP, MEGACO, SS7, or other. In addition, one of ordinary skill in the art will understand that in the following description reference to VoIP is intended also to encompass 3GPP IMS, and 3GPP IMS is also within the scope of the invention. Thus, the call flow diagrams show how the exemplary system operates under VoIP using the same architecture as in the PSTN. This demonstrates that the invention is applicable to both PSTN and VoIP or a combination of the two, and makes it apparent that the architecture shown in FIG. 2 can be used with any combination of telephone networks.

In the call flow diagrams shown in FIGS. 12 and 13, the originator calls the destinator, one of which is assumed to be an enhanced PSTN telephone and the other of which may likewise be an enhanced PSTN telephone or a VoIP phone, or it may be a cellular telephone, typically being PoC enabled. The destinator is also SIP-enabled. By “enhanced PSTN telephone” is implied either a Push-to-Talk telephone as described above with reference to FIG. 5 or a regular PSTN telephone coupled to an adapter as described above with reference to FIG. 6. The originator calls the destinator by depressing the Push-to-Talk button 61 thereby conveying to the Push-to-Talk server the destinator's identity. It will be appreciated that where an originator is registered to convey Push-to-Talk messages to only a single destinator, the identity of the destinator may be stored in the memory 74 of the line access gateway or the memory 83 of the Softswitch or may be stored in the Push-to-Talk server 46 so as to be accessible to both. In all cases, the Push-to-Talk server 46 identifies the DNRs of each destinator and establishes a one-way (half-duplex) voice channel from the originator to each of the destinators.

### Push-to-Talk Session Establishment (FIG. 12)

1. PtT initiator (PtT Device A) pushes the PtT button. AGW-A gets the indication.
2. AGW-A notifies the SSW that a “PtT push” event occurred for party A.
3. The SSW acknowledges AGW-A's notification.
4. The SSW queries the PtT Server for PtT information for party A.
5. The PtT Server queries the GLMS for PtT information for party A
6. The GLMS retrieves the info and replies to the PtT Server
7. The PtT Server replies with the PtT information for party A.
8. The SSW sends a connect command to AGW-B for receive voice traffic only.

In case of multiple targets (i.e. B,C,D and so on) this is done for each party.
9. AGW-B acknowledges the SSW command.
10. The SSW sends a connect command to AGW-A for send voice traffic only.
11. AGW-A acknowledges the SSW command.
12. The SSW sends a signal command to AGW-B: “PtT recv”. In case of multiple targets (i.e. B,C,D and so on) this is done for each party.
13. AGW-B sends a command to PtT Device B to activate the speaker and play a “PtT begin” special tone.
14. The SSW sends a signal command to AGW-A: “PtT send”.
15. AGW-A sends a command to PtT Device A to play a “PtT begin” special tone.
16. AGW-B acknowledges the SSW command.
17. AGW-A acknowledges the SSW command.
18. The SSW sends event “PtT begin” to the ECS.
19. The ECS acknowledges the SSW message.
20. One-way voice channel from A to B is established.

### Push-to-Talk Session Tear-Down (FIG. 13)

1. AGW-A indicates that no-voice timeout expires: i.e. when the baby is silent for over X seconds (meaning the timeout expired), the telephone notifies the AGW that it is time to tear down the connection.
2. AGW-A notifies the SSW that a “PtT release” event occurred for party A.
3. The SSW acknowledges AGW-A's notification.
4. The SSW sends a disconnect command to AGW-B. In case of multiple targets (i.e. B, C, D and so on) this is done for each party.
5. AGW-B acknowledges the SSW command.
6. The SSW sends a disconnect command to AGW-A.
7. AGW-A acknowledges the SSW command.
8. The SSW sends event “PtT end” to the ECS.
9. The ECS acknowledges the SSW message.
10. One-way voice channel from A to B is terminated.

### Call Process for VoIP Parties: Baby-Sitter Application

As explained above with reference to FIG. 11, the Baby-Sitter application is a feature which is based on the same implementation as the regular Push-to-Talk feature, with some additional functionality. The Baby-Sitter application allows the ‘Baby’ to burst into a ‘one-way-call’ without pressing a button. Instead of the button, the Push-to-Talk special telephone utilizes the sound sensor 62 to detect voice, and if the voice level is above a selectable threshold, then the telephone activates the call setup as if a Push-to-Talk button were pressed.

This application also includes a means to perform ‘Store and Forward’ to the voice which was sounded by the ‘Baby’. The purpose of this feature is to overcome a situation in which the ‘Baby’ cries out for a moment, and then stops. The cry may end by the time that the call can be established, in which case the ‘Sitter’ may not hear anything. The Push-to-Talk Baby-Sitter application solves this problem by storing the voice within a buffer in the AGW, and transmitting the ‘Baby's’ voice with a constant delay.

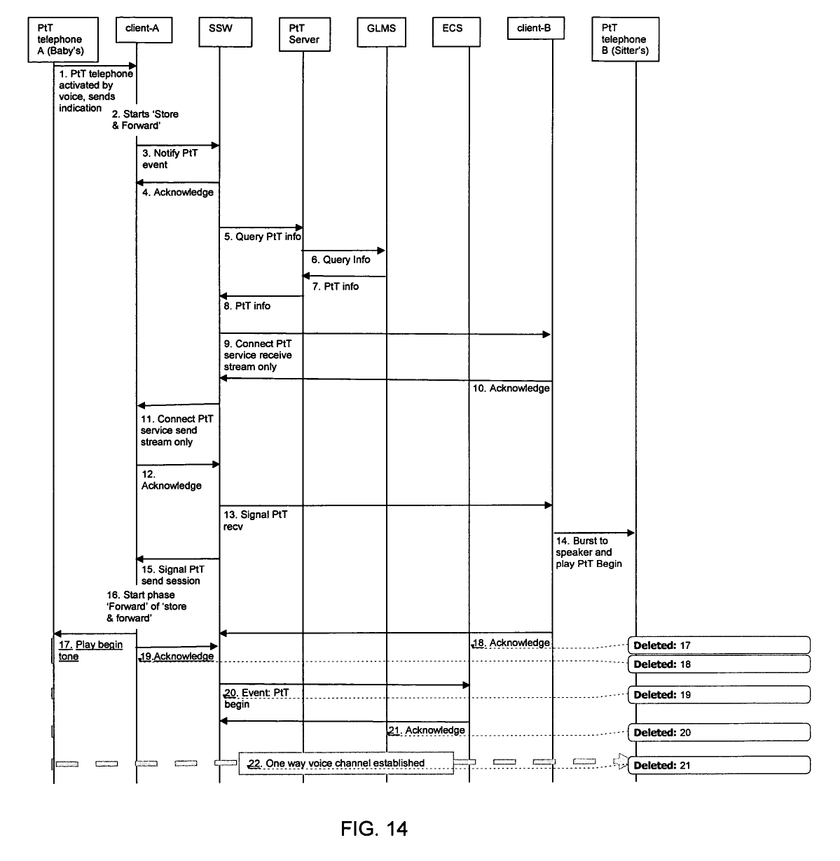

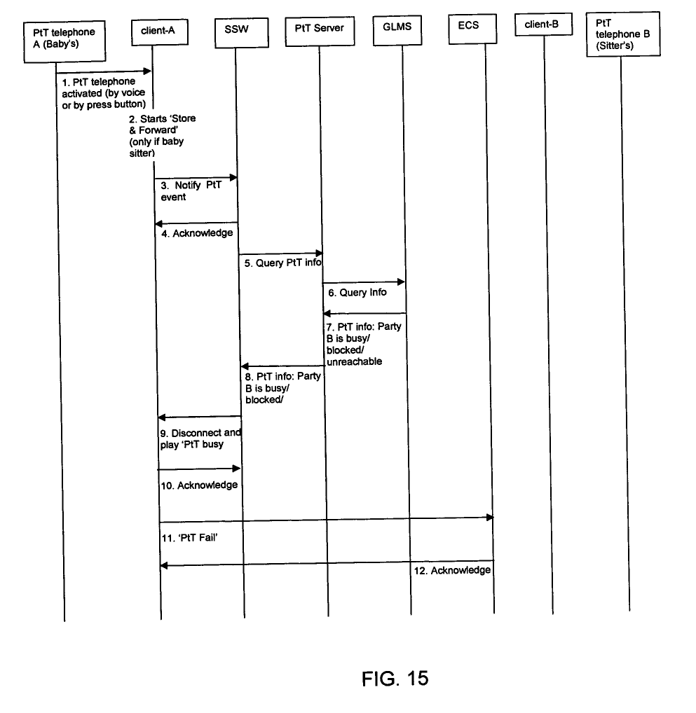

### Baby-Sitter Application Call Establishment (FIG. 14)

1. PtT initiator (PtT Telephone A) is activated upon “voice indication”. PtT Client-A (AGW-A) gets the indication.
2. PtT Client-A (AGW-A) starts the “store and forward” procedure.
3. PtT Client-A (AGW-A) notifies the SSW that a “PtT push” event occurred for party A.
4. The SSW acknowledges PtT Client-A's (AGW-A's) notification.
5. The SSW queries the PtT Server for PtT information for party A.
6. The APS approaches the GLMS and its database to retrieve the info.
7. The PtT Server replies with the PtT information and authentication confirmation for party A.
8. PtT Server passes the info to the Softswitch
9. The SSW sends a connect command to PtT Client-A (AGW-B) for receive voice traffic only. In case of multiple targets (i.e. B, C, D and so on) this is done for each party.
10. PtT Client-B (AGW-B) acknowledges the SSW command.
11. The SSW sends a connect command to PtT Client-A (AGW-A) for send voice traffic only.
12. PtT Client-A (AGW-A) acknowledges the SSW command.
13. The SSW sends a signal command to PtT Client-B (AGW-B): “PtT recv”. In case of multiple targets (i.e. B, C, D and so on) this is done for each party.
14. AGW-B sends a command to PtT Telephone B to activate the speaker and play a “PtT begin” special tone.
15. The SSW sends a signal command to PtT Client-A (AGW-A): “PtT send”.
16. PtT Client-A (AGW-A) starts the second phase of the “store and forward” procedure (forward).
17. Play begin tone.
18. PtT Client-B (AGW-B) acknowledges the SSW command.
19. PtT Client-A (AGW-A) acknowledges the SSW command.
20. The SSW sends event “PtT begin” to the ECS.
21. The ECS acknowledges the SSW message.
22. One-way voice channel from A to B is established.

### Push-to-Talk Session Setup Process for VoIP Parties: Busy/Blocked Scenario (FIG. 15)

This scenario relates to the situation where an originator attempts to establish a Push-to-Talk call to a blocked or busy destinator and is applicable for both regular Push-to-Talk calls and for the Baby-sitter application.

A blocked destinator may be one who activated a “Do not Disturb” option by dialing a code or through a web interface, that allows subscribers to make changes in their service portfolio or activate/deactivate features.
1. PtT initiator (PtT Telephone A) is activated upon “voice indication” or by pushing the PtT button. PtT Client-A (AGW-A) gets the indication.
2. PtT Client-A (AGW-A) starts the “store and forward” procedure (only baby seat application).
3. PtT Client-A (AGW-A) notifies the SSW that a “PtT push” event occurred for party A.
4. The SSW acknowledges PtT Client-A's (AGW-A's) notification.
5. The SSW queries the PtT Server for PtT information for party A.
6. The PtT Server approaches the GLMS and its database to retrieve the info.
7. The PtT Server replies with the PtT information and authentication confirmation for party A. The indication: B party is busy/blocked/unreachable.
8. The SSW begins the “unsuccessful session procedure” that MUST contain:
9. The SSW sends a disconnect command to PtT Client-A (AGW-A) and a request to play a “PtT busy tone”.
10. PtT Client-A (AGW-A) acknowledges the SSW command.
11. The SSW sends event “PtT failed <cause code> <application type>” to the ECS.
12. The ECS acknowledges the SSW message.

One of ordinary skill in the art will understand that the client and the line access gateway may be suitably programmed computers. In this context, it is to be noted that the borderline between portable telephones and computers is becoming increasingly vague since both may be equipped with a processor, memory and internal program as well as interfaces to peripheral equipment, such as a display, which may be built-in. Therefore, for the purpose of interpreting the attached claims no distinction is implied and it is to be understood that reference to a “portable telephone” and to “telephone” may equally apply to a computer having a suitable communications interface. Likewise, the invention contemplates a computer program being readable by a computer for executing the method of the invention. The invention further contemplates a machine-readable memory tangibly embodying a program of instructions executable by the machine for executing the method of the invention.

Likewise, although the embodiments have been described with particular reference to PoC enabled devices, it is to be understood that this is by way of example only. There are obvious commercial advantages in exploiting the PoC standard because it is already being used extensively in cellular telephony to convey audio Push-to-Talk. However, the principles of the invention are also applicable to other protocols for allowing real time video streaming data to be conveyed between two or more portable telephones or equivalent devices.

The above description of illustrative, non-limiting embodiments has been given by way of an example. The above and other features of the invention including various novel method steps and a system and a device of the various novel components have been particularly described with reference to the accompanying drawings and pointed out in the claims. It will be understood that the particular process and construction of parts embodying the invention is shown by way of an illustration only and not as a limitation of the invention. The principles and features of this invention may be employed in varied and numerous embodiments without departing from the scope of the invention as defined by the appended claims and equivalents thereof.

1. An access gateway for a telephone communication system adapted to receive a call signal from an originator indicative of a desire to establish a Push-to-Talk channel with at least one destinator, said access gateway comprising:
an identification unit for identifying an address of each destinator,
a communication port for conveying respective DNRs of the originator and each destinator to a Softswitch coupled to the access gateway for allowing the Softswitch to verify that the DNRs correspond to Push-to-Talk enabled telephones and that the originator is registered to establish a Push-to-Talk channel with each of said destinators, if so, for conveying to each of the destinators an instruction received from the Softswitch to activate a speaker coupled to each of the destinators, and
a half-duplex switch responsive to the or each destinator going off-hook for establishing a one-way voice channel from the originator to each of the destinators.

2. The access gateway according to claim 1, wherein the instruction is a metering pulse or a reverse polarity signal.

3. The access gateway according to claim 1, wherein the instruction is embedded within a CLI (calling line identification).

4. The access gateway according to claim 1 being adapted to generate a first dial tone for a limited time period followed by a second dial tone and for interpreting a DNR initiated by an originator party during said first dial tone as a push to talk call and for interpreting a DNR initiated by an originator party during said second dial tone as a regular call.

5. The access gateway according to claim 1 being adapted to generate a first dial tone for a limited time period followed by a second dial tone and for interpreting a DNR initiated by an originator party during said first dial tone as a regular call and for interpreting a DNR initiated by an originator party during said second dial tone as a push to talk call.

6. The access gateway according to claim 1 further including a store and forward unit for storing voice data received from the originator and forwarding to the destinator during a Push-to-Talk session.

7. The access gateway according to claim 1 further including a full-duplex switch responsive to one or more destinators completing the call for establishing a two-way voice channel between the originator and said one or more destinators.

8. A Softswitch for a telephone communication system adapted to receive a call signal from an originator coupled to the Softswitch via an access gateway, said call signal being indicative of a desire to establish a Push-to-Talk channel with at least one destinator, said Softswitch comprising:
a communication port for receiving respective DNRs of the originator and each destinator from the access gateway, and
a verification unit coupled to the communication port for verifying that the DNRs correspond to Push-to-Talk enabled telephones and that the originator is registered to establish a Push-to-Talk channel with each of said destinators, and
an instruction unit coupled to the verification unit and responsive to the DNRs corresponding to Push-to-Talk enabled telephones and to the originator being registered to establish a Push-to-Talk channel with each of said destinators for sending an instruction to the access gateway for instructing the access gateway to activate a speaker coupled to each of the destinators and establish a uni-directional voice channel from the originator to each of the destinators.

9. The Softswitch according to claim 8, further including a message conversion unit coupled to the communication port for converting a message between a first format associated with the access gateway and a second format associated with a telephone network of a different type coupled to the Softswitch.

10. The Softswitch according to claim 9, wherein the telephone network is a cellular telephone network.

11. A method for providing a baby-sitting service between an originator and a destinator, the method comprising:
locating an originator telephone having Push-to-Talk capability in voice proximity to an infant,
locating a destinator telephone having Push-to-Talk capability in voice proximity to a baby sitter, said originator and destinator telephones being registered to establish a Push-to-Talk channel with each other, and
responsive to the baby expressing distress by sound, establishing a Push-to-Talk channel between the originator and the destinator so as to enable the destinator to hear the baby via a one-way voice channel.

12. The method according to claim 11, further including storing voice data emitted by the baby prior to establishing said one-way voice channel and forwarding to the baby sitter after establishing said one-way voice channel.

13. The method according to claim 11, further including establishing a one-way voice channel between the baby sitter and the baby so as to allow the baby to hear the baby sitter.

14. An adapter for enabling a destinator to receive a Push-to-Talk call from an originator, the adapter comprising:
a connector for connecting to the destinator, and
a half-duplex switch responsive to an instruction for activating a speaker coupled to the destinator and establishing a uni-directional voice channel from the originator to the destinator.

15. The adapter according to claim 14, further including a full-duplex switch for establishing a two-way voice channel between the originator and the destinator.

16. The adapter according to claim 15, wherein the full-duplex switch is a pushbutton.

17. The adapter according to claim 16, wherein the pushbutton is operable between a first state wherein the two-way voice channel is established between the originator and the destinator and a second state wherein a one-way voice channel is established from the originator to the destinator.

18. The adapter according to claim 14 being integral with the destinator.

19. The adapter according to claim 14 wherein the speaker is contained within the adapter and is coupled to the destinator via the connector.

20. A method for receiving a call signal access from an originator indicative of a desire to establish a Push-to-Talk channel with at least one destinator in a telephone communication system, said method comprising:
identifying a DNR of each destinator;
conveying respective DNRs of the originator and each destinator to a Softswitch for allowing the Softswitch to verify that the DNRs correspond to Push-to-Talk enabled telephones and that the originator is registered to establish a Push-to-Talk channel with each of said destinators; if so,
receiving an instruction from the Softswitch to activate a speaker coupled to each of the destinators and establish a uni-directional voice channel from the originator to each of the destinators;
conveying the instruction to each of the destinators for activating a speaker coupled to each of the destinators; and
establishing a one-way voice channel from the originator to each of the destinators in response to the or each destinator going off-hook.

21. A method for receiving a call signal access from an originator indicative of a desire to establish a Push-to-Talk channel with at least one destinator in a telephone communication system, said method comprising:
receiving respective DNRs of the originator and each destinator from an access gateway;
verifying that the DNRs correspond to Push-to-Talk enabled telephones and that the originator is registered to establish a Push-to-Talk channel with each of said destinators; and
conveying an instruction to the access gateway to activate a speaker coupled to each of the destinators and establish a uni-directional voice channel from the originator to each of the destinators in response to the DNRs corresponding to Push-to-Talk enabled telephones and to the originator being registered to establish a Push-to-Talk channel with each of said destinators.

22. A program storage device readable by machine, tangibly embodying a program of instructions executable by the machine to perform a method for receiving a call signal access from an originator indicative of a desire to establish a Push-to-Talk channel with at least one destinator in a telephone communication system, said method comprising:
identifying an address of the destinator;
conveying respective DNRs of the originator and each destinator to a Softswitch for allowing the Softswitch to verify that the DNRs correspond to Push-to-Talk enabled telephones and that the originator is registered to establish a Push-to-Talk channel with each of said destinators; if so,
receiving an instruction from the Softswitch to activate a speaker coupled to each of the destinators and establish a uni-directional voice channel from the originator to each of the destinators;
conveying the instruction to said destinators; and
establishing a one-way voice channel from the originator to each of the destinators in response to the or each destinator going off-hook.

23. A computer program product comprising a computer useable medium having computer readable program code embodied therein for receiving a call signal access from an originator indicative of a desire to establish a Push-to-Talk channel with at least one destinator in a telephone communication system, said computer program product comprising:
computer readable program code for causing the computer to identify an address of each destinator;
computer readable program code for causing the computer to convey respective DNRs of the originator and each destinator to a Softswitch for allowing the Softswitch to verify that the DNRs correspond to Push-to-Talk enabled telephones and that the originator is registered to establish a Push-to-Talk channel with each of said destinators;
computer readable program code for causing the computer to receive an instruction from the Softswitch to activate a speaker coupled to each of the destinators and establish a unidirectional voice channel from the originator to each of the destinators if the DNRs correspond to Push-to-Talk enabled telephones and the originator is registered to establish a Push-to-Talk channel with said destinators;
computer readable program code for causing the computer to convey the instruction to each of the destinators; and
computer readable program code for causing the computer to establish a one-way voice channel from the originator with one or more of the destinators going off-hook.

24. A program storage device readable by machine, tangibly embodying a program of instructions executable by the machine to perform a method for receiving a call signal access from an originator indicative of a desire to establish a Push-to-Talk channel with at least one destinator in a telephone communication system, said method comprising:
receiving respective DNRs of the originator and each destinator from an access gateway;
verifying that the DNRs correspond to Push-to-Talk enabled telephones and that the originator is registered to establish a Push-to-Talk channel with each of said destinators; and
conveying an instruction to the access gateway to activate a speaker coupled to each of the destinators and establish a uni-directional voice channel from the originator to each of the destinators if the DNRs correspond to Push-to-Talk enabled telephones and to the originator is registered to establish a Push-to-Talk channel with each of said destinators.

25. A computer program product comprising a computer useable medium having computer readable program code embodied therein for receiving a call signal access from an originator indicative of a desire to establish a Push-to-Talk channel with at least one destinator in a telephone communication system, said computer program product comprising:
computer readable program code for causing the computer to receive respective DNRs of the originator and each destinator from an access gateway;
computer readable program code for causing the computer to verify that the DNRs correspond to Push-to-Talk enabled telephones and that the originator is registered to establish a Push-to-Talk channel with each of said destinators; and
computer readable program code for causing the computer to convey an instruction to the access gateway to activate a speaker coupled to each of the destinators and establish a uni-directional voice channel from the originator to each of the destinators if the DNRs correspond to Push-to-Talk enabled telephones and the originator is registered to establish a Push-to-Talk channel with each of said destinators.
